(19) United States
(12) Patent Application Publication
(10) Pub. No.: US 2008/0316164 A1
(43) Pub. Date: Dec. 25, 2008

(54) Display Product Providing a Night Light Illumination Mode

(75) Inventor: Kok Siang Tan, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,996

(22) PCT Filed: Apr. 13, 2005
(86) PCT No.: PCT/IB2005/051214

§ 371 Date: Oct. 17, 2006

(30) Foreign Application Priority Data
Apr. 20, 2004 (EP) 04101627.0

(51) Int. Cl. G09G 3/36

(52) U.S. Cl. 345/102; 345/87

(57) ABSTRACT

There is described a display product (10) suitable for use in bedrooms, the display product (10) being arranged to provide a “night-light” facility. The display product (10) includes a display (20). Moreover, the display product (10) includes processing circuits (40, 50, 70, 80) for receiving one or more image signals and presenting the images on the display (20). Furthermore, the display product (10) comprises controlling circuits (100, 110, 120) for selectively switching operation of the display product (10) between a first display product mode of operation (MD1) during which program content is presented on the display (20) and a second night-light mode of operation (MD2) during which the display product (10) is operable to function at reduced power to provide night-light illumination from the display (20). Preferably, color and/or brightness of the display (20) when operating in the second mode (MD2) is user-selectable. Conveniently, the display (20) includes a back-lit liquid crystal display (LCD).

### FIELD OF THE INVENTION

The present invention relates to display products; in particular, but not exclusively, operable to present images, being part of program content or comprising data to associated viewers.

### BACKGROUND TO THE INVENTION

Display products are well known and were originally installed for use as a television in domestic communal rooms, for example lounges and similar locations. On account of miniaturization and manufacturing cost reduction, display products have become relatively inexpensive so that users are now able to duplicate television facilities in their bedrooms for enabling them to watch display product program material whilst resting in bed, for example at evening time. Televisions for use in bedrooms are generally smaller than those used in communal rooms where broad-screen television apparatus, for example HDTV, with multi-channel surround sound has become an accepted norm. Moreover display products are used for other purposes, such as a monitor for viewing images comprising data from a computer. Such a computer with monitor may also be installed in a bedroom.

It is also standard equipment in bedrooms to include bedside lamps for enabling users to read books and similar printed literature in bed prior to falling asleep. Such lamps are conventionally installed so that their users are able to switch them off without having to leave their beds.

More recently, numerous types of illumination devices have been described capable of providing pleasing color effects. Such devices are, for example, described in WO 01/82657, which concerns high-brightness light emitting diodes (LEDs) combined with associated processor control for producing a variety of pleasing display and illumination effects. One particular lighting device elucidated includes two or more LEDs for producing 2 different spectra and a display screen for providing information.

### SUMMARY OF THE INVENTION

The inventor has appreciated that domestic bedrooms are becoming increasingly filled with user equipment, for example personal computers, televisions, and audio high-fidelity systems. Moreover, the inventor has identified that contemporary accommodation, especially in cities, is often less spacious on account of population density pressures.

In order to address the problem of limited available space in venues such as bedrooms where display products are increasingly employed, the inventor has devised the present invention.

An object of the present invention is to provide a display product which is capable of providing space saving. The invention is defined by the independent claims. The dependent claims define advantageous embodiments.

According to a first aspect of the present invention, there is provided a display product including:

(a) a display;

(b) processing means for receiving one or more image signals and presenting the images on the display; and

(c) controlling means for selectively switching operation of the display product between at least a first display product mode of operation during which images are presented on the display and a second night-light mode of operation during which the display product is operable to function at reduced power to provide night-light illumination from the display.

The invention is of advantage in that the display product is synergistically capable of providing additional functions which are complementary to its primary function of presenting program content. So, no extra space is required for a night-light as the display product itself fulfils this function.

The inventor has appreciated that display products suitable for use in venues such as bedrooms are capable of providing increased functionality. Moreover, the inventor has devised the present invention against a prevailing prejudice that display products, such as televisions or monitors are primarily based on thermionic vacuum components, namely television vacuum tubes, whose electron guns and phosphor screens have limited operating lifetime. This prejudice also pertains to back-lighting units in liquid crystal display (LCD) televisions and monitors which have recently become commercially available at affordable prices for domestic use. Hence, a conventional approach is to energize such apparatus only in situations where the apparatus is to be viewed by one or more users, for example to watch program content.

Preferably, in the display product, the controlling means includes switching means for disconnecting power to at least a part of the processing means when the display product is switched to the second mode of operation. Reducing power dissipation in the processing means in the second mode is of advantage in that it is capable of prolonging operating lifetime of the display product.

More preferably, in the display product, the switching means is arranged to disconnect power to the processing means on an intermittent basis so as to enable the processing means to perform one or more functions in an intermittent manner. Such intermittent application of power is capable of enabling the processing means to undertake on a pseudo-continuous basis certain specialist functions, for example receiving time clock information via wireless, and periodically presenting time information on the display, for example in a manner of a bed-side alarm clock when operating in the second mode.

Preferably, in the display product, the switching means is operable to reduce clocking rates applied to at least one of the processing means and the controlling means when in the second mode to reduce power consumption within the display product.

Preferably, in the display product, the controlling means incorporates one or more sensors for sensing environmental conditions in proximity to the display product for measuring environmental characteristics, and selectively switching the display product to the second mode in event of one or more of the characteristics exceeding one or more predefined levels. Connection of the one or more sensors to the controlling means enables the display product to provide yet further functionality at relatively little additional cost.

Preferably, the display product is operable to consume substantially an order of magnitude less power in the second night-light mode relative to the first mode. This order of magnitude less power consumption is capable of providing the television with prolonged operating lifetime when functioning at reduced power levels.

In an embodiment the display comprises a back-lighting unit for generating back-lighting radiation and a selectively light-transmissive display unit for selectively transmitting the radiation to present one or more images to a user of the display product. Use of a back-lighting unit as a source of light radiation is of benefit in that these units are contemporarily inexpensive, compact and offer potentially high quantum efficiency of electrical power to light radiation conversion. More preferably, the back-lighting unit is operable to employ one or more of the following technologies for generating the back-lighting radiation: gas discharge, gas discharge in combination with one or more phosphors, light emitting diodes (LEDs), polymer junction light emitters, field emitters.

Preferably, the display product is operable to provide one or more of the following functions when in the second mode: fire alarm, intruder alarm. These additional functions are capable of being synergistically provided by the display product in addition to the second mode night-light function.

Preferably, in the display product, the controlling means is arranged so that color and/or brightness of radiation emitted from the display when the display product is operated in the second mode is user adjustable, for example to match room decor or desired brightness level.

According to a second aspect of the invention, there is provided a method of providing a night-light function on a display product, the method comprising steps of:
(a) arranging for the display product to include a display, processing means for receiving one or more image signals and presenting the images on the display, and controlling means coupled to the display and the processing means; and
(b) selectively switching operation of the display product between at least a first display product mode of operation during which images are presented on the display and a second night-light mode of operation during which the display product is operable to function at reduced power to provide night-light illumination from the display.

According to a third aspect of the invention, there is provided software for execution in controlling means of a display product according to the first aspect of the invention; the software being executable to enable selective switching of the display product between at least a first display product mode of operation during which images are presented on a display of display product, and a second night-light mode of operation during which the display product is operable to function at reduced power to provide night-light illumination from the display.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

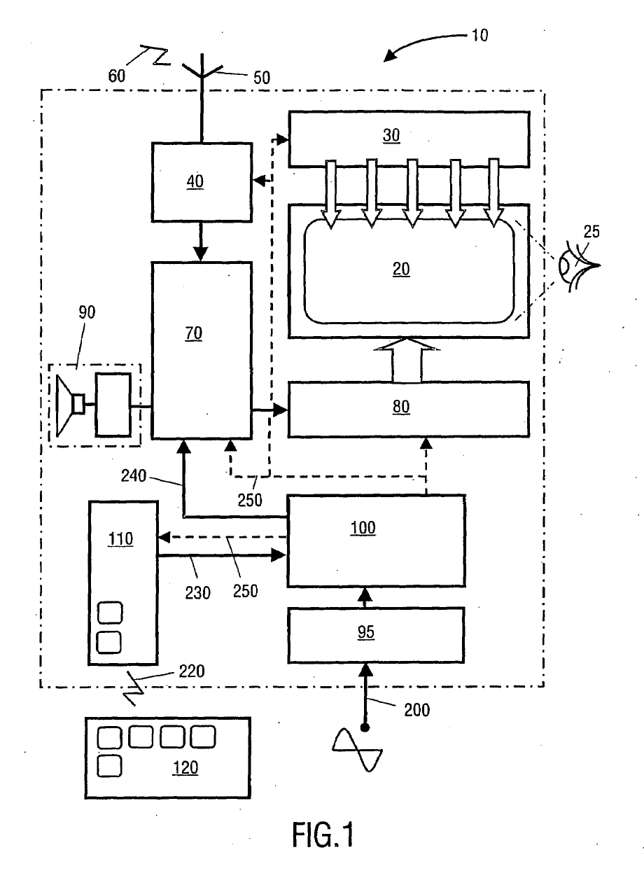

FIG. 1 is a schematic diagram of a display product according to the invention;

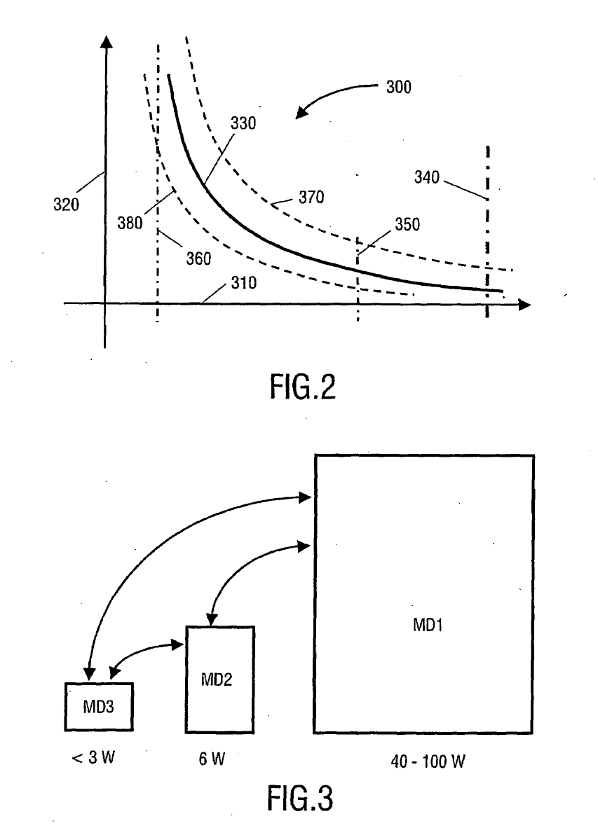

FIG. 2 is a graph depicting operating lifetime as a function of operating power; and

FIG. 3 is a graphical illustration of display product power consumption when operating in three different modes MD1, MD2 and MD3.

### DESCRIPTION OF EMBODIMENTS OF THE INVENTION

Referring to FIG. 1, there is shown a television indicated generally by 10; the television 10 is an example embodiment of a display product according to the invention. Other examples of display products are monitors, front projectors and rear projectors. The television 10 includes a liquid crystal device (LCD) display 20 provided with a back-lighting unit 30 for presenting images to one or more viewers 25. The television 10 further comprises a radio frequency front-end circuit 40 coupled to an antenna 50 for receiving UHF television wireless radiation 60 and generating corresponding heterodyne intermediate frequency signals. Optionally, the front-end circuit 40 can also be coupled to receive fiber-optic-cable television program content. In addition or alternatively the television may have an external input (not shown) for receiving input signals from another product such as a DVD player. The front-end circuit 40 is coupled to a demodulator circuit 70. Moreover, the demodulator circuit 70 is arranged to receive the intermediate frequency signals from the front-end circuit 40 to generate corresponding sound and vision signals to a display buffer 80 and to an audio circuit 90 including one or more loud-speakers. The buffer 80 is arranged to drive the display 20, for example feeding pixel signals to thin-film-transistors (TFT) associated with LCD pixels of the display 20, so as to present an image to the one or more viewers 25. Moreover, the LCD pixels of the display 20 are operable to selectively transmit components of white-color illumination generated by the back-lighting unit 30 to present aforementioned images to the one or more viewers 25.

The television 10 is arranged to be connected at its power supply unit 95 to a source of power, for example a mains electrical supply, by way of a power connection 200. The supply unit 95 is operable to convert the mains supply to corresponding rectified lower voltage supplies which are coupled via a control unit 100 to the front-end circuit 40, to the demodulator circuit 70, to the buffer 80 and to the back-lighting unit 30 by way of power connections 250 within the television 10. The control unit 100 is connected to a user interface 110 via a data bus 230 to receive input selection information from the one or more viewers 25. Moreover, the control unit 100 is also connected via a control bus 240 to the demodulator circuit 70 for controlling television channel selection. The television 10 also comprises a remote control unit 120 coupled in a cordless manner by a wireless or optical link 220 to the user interface 110. The one or more viewers 25 are thus capable of entering data at the remote control unit 120 for instructing the control unit 100 to configure the television 10 in various modes of operation which will be elucidated in more detail later.

Operation of the television 10 will now be described in more detail.

The television 10 functions in two modes, namely:
(a) in a first television mode MD1 where it receives, for example, the wireless radiation 60, for example at UHF and/or microwave frequencies, and/or optical-optical cable television transmissions bearing program content; the television 10 presents images with such content to the one or more viewers 25; and
(b) in a second night-light mode MD2 where the television 10 provides a night-light facility by operating the display 20 at reduced power levels.

In case the television is coupled to a computer or a data network it may display images based on data received from the computer or the network. The same applies if the display product is a monitor.

The inventors have appreciated that components within the television 10, for example the display 20 and its associated back-lighting unit 30 as well as other electronic components of the television 10, have an operating lifetime characteristic as described approximately by FIG. 2. This characteristic is not generally appreciated as televisions are usually either switched off or operated at some specific power level as designed by their manufacturers. In FIG. 2, there is shown a graph indicated generally by 300 including an abscissa axis 310 denoting mean operating power and an ordinate axis 320 denoting operating lifetime of the television 10. A curve 330 is plotted on the graph 300 and presents a trade-off between operating lifetime and mean operating power level. Associated with the curve 330 is:
(a) an upper operating power limit 340;
(b) a high power level 350 corresponding to a dissipation in the television 10 during the first television mode of operation MD1; and
(c) a lower power level 360 corresponding to the aforementioned night-light mode of operation MD2.

Curves 370, 380 relate to upper and lower limits of lifetime characteristics of the television 10 when mass-produced in batches, such limits being due to batch-to-batch variation between components used. The curve 330 is not limited to describing lifetime characteristics of the television 10 but can also be applied to describe other types of apparatus, for example lifetime versus operating temperature of a jet engine or nuclear reactor core. In certain situations, the curve 330 will have distinct steps where certain component parts have distinct lifetime-limiting processes which have associated activation energies, for example in a manner akin to Ahrenius activation energies.

Thus, the inventor has envisaged that operating the display 20 and the back-lighting unit 30 at reduced power greatly increases their operating lifetime rendering them suitable for use in providing subdued lighting over longer periods of time. For example, the television 10 used to provide night lighting for eight hours each evening for a period of five years will be operating in its low power mode MD2, namely at the lower power level 360; such a duration corresponds to an operational lifetime of 15000 hours. In comparison, a heated-filament incandescent light bulb typically has an operating lifetime in a range of 1000 to 2000 hours. In order to achieve such a long operating lifetime at low power for the back-lighting unit 30, it is preferably fabricated using light emitting diode (LED) devices, plasma discharge devices utilizing long-life phosphors or polymer light emitting devices. However, other types of light generating technology are beneficially employed, for example arrays of cold field emitters or electron tunneling emitters which, when subjected to high electric fields, function as electron emitters for generating electrons susceptible to being accelerated in an electric field for subsequently impacting onto phosphor materials to excite them and thereby generate light radiation to illuminate the display 20. Thus, the back-lighting unit 30 beneficially utilizes a lighting technology capable of providing greatly prolonged operating lifetime when energized at relatively low power.

When the television 10 functions in its second night-light mode of operation, sub-sections of the television 10 not required for use are preferably arranged to be de-energized, or at least periodically de-energized; for example, at least one of the front-end circuit 40, the demodulator 70 and the audio circuit 90 are, at least part of the time, switched-off when the television 10 operates in its second night-light mode MD2. Moreover, the control unit 100 also instructs at least one of the buffer 80 and the back-lighting unit 30 to function at reduced power; for example, power dissipation is reduced by decreasing a clocking frequency of the buffer 80 for updating data on account of its contents only needing to change relatively infrequently when operating in the second mode. Operating life-time of the power supply unit 95 is also potentially prolonged by reducing power dissipation arising therein. The unit 95 is usually conveniently implemented as a switched mode power supply including power switching semiconductor devices and electrolytic capacitors. These semiconductor devices and capacitors exhibit finite operating lifetimes on account of ageing processes occurring therein. For example, electromigration and corrosion or oxidation occurs in semiconductor device substrate conductors used to convey switching currents in the supply 95 resulting in limited operating lifetime. Moreover, drying-out characteristics in gels employed in electrolytic capacitors, such drying out being accelerated at higher temperatures due to ripple-current heating occurring in the capacitors, is also a life-time limiting factor.

Optionally, the front-end circuit 40 and the demodulator circuit 70 are arranged in the second night-light mode MD2 to be energized intermittently, for example when the television 10 is configured to receive time signals conveyed by radio for updating a time clock facility provided in the television 10 when operating in its second mode MD2; such a clock facility enables the television 10 to function also as an alarm clock with the audio circuit 90 providing an audio wake-up alarm. Moreover, the audio circuit 90 is also beneficially de-energized in the second mode of operation MD2 and only activated when the television 10 is required to generate sound, for example for providing an waking alarm clock function where the audio circuit 90 only needs to be energized when generating an alarm tone.

Optionally, for example to reassure small children watching program content on the television 10 through an evening, the television 10 can be configured to provide a night light facility in its second mode of operation for a limited time period whilst the children fall asleep and thereafter de-energize the television 10 to prolong its operating lifetime.

In the second night-light mode MD2, the one or more viewers 25 are capable of selecting a color for the display 20, for example to match decor in an associated room, for example a bedroom; preferably, choice of color is input via the remote control 120. Moreover, brightness of the display 20 in the second night light mode of operation is also adjustable, for example also via the remote control 120.

If required, the television 10 can be provided with other sensors, for example a smoke detector to raise an alarm on the display 20 and a siren tone in the audio circuit 90 in an event of smoke from a fire being detected. Such a smoke detector is preferable coupled to the control unit 100, which, in turn, is operable to generate audio/visual warnings when smoke is detected. Such smoke detection is of benefit when the one or more viewers 25 are smokers who smoke whilst in bed, or use an electric blanket in bed which is capable of setting flammable materials such as bed clothes into combustion under electrical fault conditions. Another example of a sensor is an ambient temperature sensor, which similar to the above smoke detector, is coupled to the control unit 100, which, in turn, is operable to generate a display of the temperature and/or a warning signal if the temperature exceeds a predetermined level.

The television 10 is preferable capable of being switched from its first television mode of operation to its second night light mode of operation by using a “video mute” button or switch provided on the remote control 120. Moreover, the television 10 is conveniently implemented as a light-weight substantially planar device susceptible to being wall-mounted and placed on small table-top surfaces, for example in bedrooms. Optionally, the television 10 is included as an integral part of bed furniture, for example built into a foot panel at an end region of a bed.

In the second night-light mode of operation, the television 10 emits just sufficient illumination:
(a) for preventing the one or more viewers 25 from falling over domestic obstacles such as chairs when the one or more viewers 25 manoeuver about a room, for example a bedroom, at night time; or
(b) checking the time on a clock without needing to energize a main room light and thereby potentially avoiding disturbing another person present.

If required, the television 10 can be provided with a third mode of operation MD3 where the night-light functionality is also de-energized in a manner as represented in FIG. 3; the third mode MD3 corresponds to a low-power “standby mode”. In FIG. 3, the first, second and third modes of operation are denoted by MD1, MD2, MD3 respectively where relative sizes of areas of rectangles depict relative power consumption of the television 10. In the third mode MD3, power consumption of the television 10 is preferably less than 3 Watts (<3 W). In contrast, the television 10 consumes in the order of 6 Watts (6 W) in its night-light mode MD2, predominantly in the back-lighting unit 30. However, in the first television mode MD1, the television 10 consumes in the order of 40 to 100 Watts (40-100 W) depending upon area of the display 20 and its associated back-lighting unit 30, as well as the brightness setting selected by the one or more viewers 25. The television 10 can be rapidly switched between these modes MD1, MD2, MD3, for example by depressing buttons or switches on the remote control 120.

Optionally, a clocking rate of the control unit 100, for example a clocking frequency of a microprocessor or microcontroller incorporated therein, is reduced in the second and third modes MD2, MD3 to conserve power.

Optionally, the television 10 can be provided with an ultrasonic motion sensor so that, upon detecting motion using the ultrasonic sensor, the television 10 is arranged to switch automatically from its third mode MD3 to its second night-light mode MD2 of operation. Such a feature avoids the one or more viewers 25 needing to find the remote control in darkness and thus potentially avoids user frustration. Moreover, the feature is advantageous in emergency situations, for example in an event of fire, so that users can find their way to safety exits.

It should be noted that the above-mentioned embodiments illustrate rather than limit the invention, and that those skilled in the art will be able to design many alternative embodiments without departing from the scope of the appended claims. For example, the allocation of the features in the various blocks of software or hardware may be changed without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A display product (10) including:
(a) a display (20);
(b) processing means (40, 50, 70, 80) for receiving one or more image signals and presenting the images on the display (20); and
(c) controlling means (100, 110, 120) for selectively switching operation of the display product (10) between at least a first display product mode of operation (MD1) during which images are presented on the display (20) and a second night-light mode of operation (MD2) during which the display product (10) is operable to function at reduced power to provide night-light illumination from the display (20).

2. A display product (10) according to claim 1, wherein the controlling means (100, 110, 120) includes switching means (100, 250) for disconnecting power to at least a part of the processing means (40, 50, 70, 80) when the display product (10) is switched to the second mode of operation (MD2).

3. A display product (10) according to claim 2, wherein the switching means. (100, 250) is arranged to disconnect power to the processing means (40, 50, 70, 80) on an intermittent basis so as to enable the processing means (40, 50, 70, 80) to perform one or more functions in an intermittent manner.

4. A display product (10) according to claim 2, wherein the switching means (100, 250) is operable to reduce clocking rates applied to at least one of the processing means (40, 50, 70) and the controlling means (100) when in the second mode (MD2) to reduce power consumption within the display product (10).

5. A display product (10) according to claim 1, wherein the controlling means (100, 110, 120) incorporates one or more sensors for sensing environmental conditions in proximity to the display product (10) for measuring environmental characteristics, and selectively switching the display product (10) to the second mode (MD2) in event of one or more of the characteristics exceeding one or more predefined levels.

6. A display product (10) according to claim 1, the display product being operable to consume substantially an order of magnitude less power in the second night-light mode (MD2) relative to the first display product mode (MD1).

7. A display product (10) according to claim 1, wherein the display (20, 30) comprises a back-lighting unit (30) for generating back-lighting radiation and a selectively light-transmissive display unit (20) for selectively transmitting the radiation to present one or more images to a user of the display product (10).

8. A display product (10) according to claim 1, the display product (10) being operable to provide one or more of the following functions when in the second mode: fire alarm, intruder alarm.

9. A display product (10) according to claim 1, wherein the controlling means (100, 110, 120) is arranged so that color and/or brightness of radiation emitted from the display (20) when the display product (10) is operated in the second mode (MD2) is user adjustable.

10. A method of providing a night-light function on a display product (10), the method comprising steps of:
(a) arranging for the display product (10) to include a display (20), processing means (40, 50, 70, 80) for receiving one or more image signals and presenting the images on the display (20), and controlling means (100, 110, 120) coupled to the display (20) and the processing means (40, 50, 70, 80); and
(b) selectively switching operation of the display product (10) between at least a first display product mode of operation (MD1) during which images are presented on the display (20) and a second night-light mode of operation (MD2) during which the display product (10) is operable to function at reduced power to provide night-light illumination from the display (20).

11. Software for execution in controlling means (100) of a display product (10) according to claim 1, the software being executable to enable selective switching of the display product (10) between at least a first display product mode of operation (MD1) during which images are presented on a display (20) of display product (10), and a second night-light mode of operation (MD2) during which the display product (10) is operable to function at reduced power to provide night-light illumination from the display (20).
